(19) United States
(12) Patent Application Publication
(10) Pub. No.: US 2026/0290108 A1
(43) Pub. Date: Sep. 24, 2026

(54) AMMUNITION VENDING MACHINE

(71) Applicants: Grant Magers, Richardson, TX (US); Lawrence Songer, Hurst, TX (US)

(72) Inventors: Grant Magers, Richardson, TX (US); Lawrence Songer, Hurst, TX (US)

(21) Appl. No.: 19/070,220

(22) Filed: Mar. 4, 2025

Related U.S. Application Data
(63) Continuation of application No. 18/811,074, filed on Aug. 21, 2024, now abandoned.
(60) Provisional application No. 63/660,826, filed on Jun. 17, 2024.

(51) Int. Cl. G07F 9/00; G07F 7/10; G07F 9/02; G07F 11/00

(52) U.S. Cl. CPC G07F 9/009; G07F 7/10; G07F 9/002; G07F 9/0235; G07F 9/026; G07F 11/00

(57) ABSTRACT

An ammunition vending machine integrated with AI, ID scanner and facial recognition software is presented, wherein the vending machine has an inventory of ammunition. The user makes a purchase by choosing an ammunition, selecting a payment mode, then scanning the ID of the user, and matching the face of the user to the ID to prevent theft and increase security.

### BACKGROUND

### 1. Field of the Invention

The present invention relates generally to vending machines, and more specifically to an ammunition vending machine.

### 2. Description of Related Art

Vending machines are automated devices designed to dispense products or services to consumers in exchange for payment. There are different kinds of vending machines such as snack and beverage vending machine, specialty vending machines, fresh food vending machines and many more.

Buying ammunition traditionally often involves accessing store employees and even dealing with open ammo boxes, facing potential stock issues and enduring lengthy processes. It also involves human error or human favoritism from selling ammunition to those who do not meet legal requirement.

Accordingly, it is an object of the present application to provide an ammunition vending machine integrated with AI, ID scanner and facial recognition that prevents theft of ammunition and scans the ID to the user and allows for making a purchase sticking to the legal standards and rules.

### DESCRIPTION OF THE DRAWINGS

FIG. 1 is a flowchart of a method of dispensing ammunition from the vending machine.

### DETAILED DECRIPTION

Illustrative cases of the system and method of use of the present application are provided below. It will of course be appreciated that in the development of any actual case, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several cases of the system are presented herein. It should be understood that various components, parts, and features of the different cases may be combined together and/or interchanged with one another, all of which are within the scope of the present application, even though not all variations and particular cases are shown in the drawings. It should also be understood that the mixing and matching of features, elements, and/or functions between various cases is expressly contemplated herein so that one of ordinary skill in the art would appreciate from this disclosure that the features, elements, and/or functions of one case may be incorporated into another case as appropriate, unless described otherwise.

The preferred case herein described is not intended to be exhaustive or to limit the invention to the precise form disclosed. It is chosen and described to explain the principles of the invention and its application and practical use to enable others skilled in the art to follow its teachings

The technology described herein fulfills an ammunition vending machine system integrated with AI, ID scanner and facial recognition software. In our preferred case, the machine is constructed from double-walled steel and uses a triple lock to prevent break in and theft. The machine is 1600 lbs and approximately 2000 lbs when stocked with ammunition. They are located inside the stores by the registers to further prevent theft and vandalism. They will also be used for selling memberships (i.e NRA, USCCA licensing etc.) and in some cases drop ship orders on accessories too large for the machine's storage.

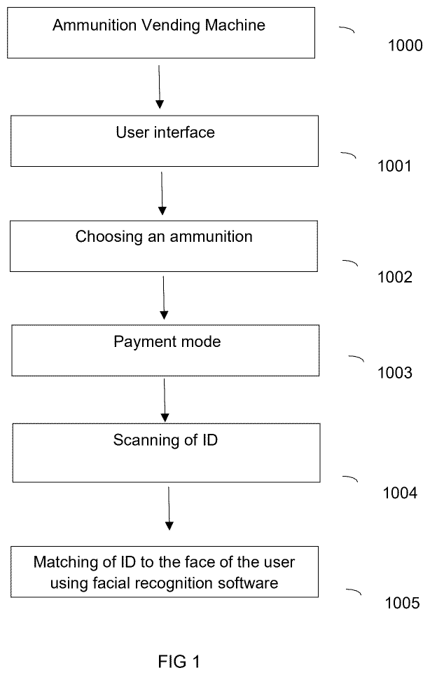

In our preferred case, FIG. 1 shows a method of dispensing ammunition from the vending machine by going to a vending machine 1000 and then choosing an ammunition 1002 as needed by the user through the user interface 1001 using the touch screen display manual. The user then selects a payment mode 1005 to make a purchase. Before making the purchase, the user interface then scans the ID 1003 of the user using the ID scanner and matches the face of the user to the ID using a facial recognition software 1004. The user is required to move their head left, right and then smile at the camera. This prevents an user from using another person's ID or trying to use a picture of a person to fool the scan. The machine meets all political and social responsibility requirements. In some cases, the method or steps could be modified including but not limiting to scanning the ID 1004 and matching the ID to the face of the user in facial recognition software 1005 first after choosing an ammunition 1002 and then paying for the purchase through a payment mode 1003. The steps may be modified for different applications as needed.

The particular cases disclosed above are illustrative only, as the cases may be modified and practiced in different but equivalent manners apparent to those skilled in the art having the benefit of the teachings herein. It is therefore evident that the particular cases disclosed above may be altered or modified, and all such variations are considered within the scope and spirit of the application. Accordingly, the protection sought herein is as set forth in the description. Although the present cases are shown above, they are not limited to just these cases but are amenable to various changes and modifications without departing from the spirit thereof.

What is claimed is:

1) An ammunition vending machine system, wherein the system comprises:
a housing unit configured to have an internal compartment configured to store a plurality of ammunition or accessories;
an user interface comprising:
a touch screen display configured to provide ammunition selection options and transaction input;
an ID scanner configured to scan an user's ID to determine eligibility;
a facial recognition software configured to scan an user to match the user to the user's ID, wherein the user is configured to move in directions comprising left, right, or center to accurately scan the user to the ID;
a payment processing system configured to integrate with the user interface and to accept payment via at atleast one of contactless card, mobile wallet, credit/debit card, or cash; and
a real-time inventory management system comprising a backend software configured to monitor quantity of items within the internal compartment, wherein all ammunition changes, image changes, and pricing changes can be done remotely on individual machines or on all machine simultaneously.

2. A method of dispensing ammunition from the ammunition vending machine comprising:
providing the ammunition vending machine system of claim 1;
choosing an ammunition on the touch screen display;
paying for the purchase via the payment processing system; and
scanning the user ID to the user via the facial recognition software.
